(19) United States
(12) Patent Application Publication
(10) Pub. No.: US 2024/0383006 A1
(43) Pub. Date: Nov. 21, 2024

(54) VIBRATION APPARATUS AND APPARATUS INCLUDING THE SAME

(71) Applicant: LG DISPLAY CO., LTD., Seoul (KR)

(72) Inventor: HyunWoo KIM, Paju-si (KR)

(73) Assignee: LG DISPLAY CO., LTD., Seoul (KR)

(21) Appl. No.: 18/640,435

(22) Filed: Apr. 19, 2024

(30) Foreign Application Priority Data
May 17, 2023 (KR) 10-2023-0063636

(51) Int. Cl. B06B 1/06

(52) U.S. Cl. CPC B06B 1/0607

(57) ABSTRACT

A vibration apparatus includes a first cover member, a second cover member, and a first vibration part and a second vibration part between the first cover member and the second cover member. The first vibration part and the second vibration part are arranged in different directions.

### CROSS-REFERENCE TO RELATED APPLICATION

This application claims the priority of Korean Patent Application No. 10-2023-0063636 filed on May 17, 2023, which is hereby incorporated by reference in its entirety.

### BACKGROUND

### Field of the Disclosure

The present disclosure relates to a vibration apparatus and an apparatus including the same.

### Description of the Background

Recently, the demands for slimmer and thinner electronic devices are increasing. In speakers applied to electronic devices, piezoelectric devices capable of being implemented with a thin thickness are attracting much attention instead of voice coils, based on the demands for slimmer and thinner devices.

### SUMMARY

Vibration apparatuses or speakers including a piezoelectric device include vibration apparatuses where a metal vibration plate is adhered to a piezoelectric device and film-type vibration apparatuses where electrodes are formed in a lower portion and an upper portion by a piezoelectric film material and a voltage is applied thereto.

Because vibration apparatuses where a piezoelectric device is adhered to a metal vibration plate are heavy in weight and film-type vibration apparatuses are low in internal temperature and are degraded in sound quality, it is required to develop vibration apparatuses for reducing a weight and enhancing sound quality.

The inventors have performed extensive research and experiments for implementing a vibration apparatus where a manufacturing process and a structure of the vibration apparatus are simplified. The inventors have invented a vibration apparatus having a new structure and an apparatus including the vibration apparatus, in which a manufacturing process and a structure of the vibration apparatus are simplified, based on the extensive research and experiments.

One or more aspects of the present disclosure are directed to providing a vibration apparatus and an apparatus including the same, in which a structure thereof and a manufacturing process are simplified.

One or more aspects of the present disclosure are directed to providing a vibration apparatus and an apparatus including the same, which may enlarge a sound radiation region to enhance a sound pressure level characteristic and/or a sound characteristic of a sound.

One or more aspects of the present disclosure are directed to providing a vibration apparatus and an apparatus including the same, in which a weight and a thickness may be reduced.

Additional features, advantages, and aspects of the present disclosure are set forth in the present disclosure and will also be apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the appended drawings.

To achieve these and other advantages and aspects of the present disclosure, as embodied and broadly described herein, in one or more aspects, a vibration apparatus may comprise a first cover member, a second cover member, and a first vibration part and a second vibration part between the first cover member and the second cover member. The first vibration part and the second vibration part may be arranged in different directions.

In one or more aspects, an apparatus may comprise a passive vibration member, and a vibration generating apparatus connected to the passive vibration member to vibrate the passive vibration member. The vibration generating apparatus may comprise a the vibration apparatus including a first cover member, a second cover member, and a first vibration part and a second vibration part between the first cover member and the second cover member. The first vibration part and the second vibration part may be arranged in different directions.

According to one or more aspects of the present disclosure, a vibration apparatus capable of simplifying a structure and a manufacturing process and an apparatus including the same may be provided.

According to one or more aspects of the present disclosure, a plurality of vibration portions may be arranged to intersect with one another in different directions, and thus, a sound radiation region may enlarge, thereby providing a vibration apparatus and an apparatus including the same for enhancing a sound pressure level characteristic and/or a sound characteristic of a sound.

According to one or more aspects of the present disclosure, since the thickness of the vibration apparatus may be reduced to reduce the weight, it is possible to implement a lightweight vibration apparatus.

According to one or more aspects of the present disclosure, process optimization through energy-saving production may be achieved by simplifying the manufacturing process.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate aspects of the disclosure and together with the description serve to explain the principle of the disclosure.

In the drawings:

FIG. 1 illustrates a vibration apparatus according to an aspect of the present disclosure;

FIG. 2 is a perspective view illustrating a connection structure between a vibration generating portion and a signal cable illustrated in FIG. 1 according to an aspect of the present disclosure;

FIG. 3 is a cross-sectional view taken along line A-A′ illustrated in FIG. 1 according to an aspect of the present disclosure;

FIG. 4 is a cross-sectional view taken along line B-B′ illustrated in FIG. 1 according to an aspect of the present disclosure;

FIG. 5 illustrates a vibration apparatus according to another aspect of the present disclosure;

FIG. 6 is a perspective view illustrating a connection structure between a vibration generating portion and a signal cable illustrated in FIG. 5 according to another aspect of the present disclosure;

FIG. 7 is a cross-sectional view taken along line C-C′ illustrated in FIG. 5 according to another aspect of the present disclosure;

FIG. 8 is a cross-sectional view taken along line D-D′ illustrated in FIG. 5 according to another aspect of the present disclosure;

FIG. 9 illustrates a vibration apparatus according to another aspect of the present disclosure;

FIG. 10 illustrates a vibration apparatus according to another aspect of the present disclosure;

FIG. 11 illustrates a vibration apparatus according to another aspect of the present disclosure;

FIG. 12 illustrates a vibration apparatus according to another aspect of the present disclosure;

FIG. 13 illustrates a sound radiation angle of a vibration apparatus according to an aspect of the present disclosure;

FIG. 14 illustrates an apparatus according to an aspect of the present disclosure; and

FIG. 15 is a cross-sectional view taken along line E-E′ illustrated in FIG. 14 according to an aspect of the present disclosure.

### DETAILED DESCRIPTION

Reference is now made in detail to aspects of the present disclosure, examples of which may be illustrated in the accompanying drawings. In the following description, when a detailed description of well-known functions or configurations may unnecessarily obscure aspects of the present disclosure, the detailed description thereof may be omitted for brevity. The progression of processing steps and/or operations described is an example; however, the sequence of steps and/or operations is not limited to that set forth herein and may be changed, with the exception of steps and/or operations necessarily occurring in a particular order.

Unless stated otherwise, like reference numerals may refer to like elements throughout even when they are shown in different drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the aspects described with reference to the accompanying drawings. The present disclosure may, however, be embodied in different forms and should not be construed as limited to the aspects set forth herein. Rather, these aspects are examples and are provided so that this disclosure may be thorough and complete to assist those skilled in the art to understand the inventive concepts without limiting the protected scope of the present disclosure.

The shapes, sizes, areas, ratios, angles, numbers, and the like disclosed in the drawings for describing aspects of the present disclosure are merely examples, and thus, the present disclosure is not limited to the illustrated details.

When the term “comprise,” “have,” “include,” “contain,” “constitute,” “make up of,” “formed of,” or the like is used, one or more other elements may be added unless a term such as “only” or the like is used. The terms used in the present disclosure are merely used to describe particular aspects, and are not intended to limit the scope of the present disclosure. The terms used herein are merely used to describe example aspects, and are not intended to limit the scope of the present disclosure. The terms of a singular form may include plural forms unless the context clearly indicates otherwise. The word “exemplary” is used to mean serving as an example or illustration. Aspects are example aspects. Aspects are example aspects. Any implementation described herein as an “example” is not necessarily to be construed as preferred or advantageous over other implementations.

In one or more aspects, an element, feature, or corresponding information (e.g., a level, range, dimension, size, or the like) is construed as including an error or tolerance range even where no explicit description of such an error or tolerance range is provided. An error or tolerance range may be caused by various factors (e.g., process factors, internal or external impact, noise, or the like). Further, the term “may” encompass all the meanings of the term “may.”

In describing a positional relationship, where the positional relationship between two parts is described, for example, using “on,” “over,” “under,” “above,” “below,” “beneath,” “near,” “close to,” “adjacent to,” “beside,” “next to,” or the like, one or more other parts may be located between the two parts unless a more limiting term, such as “immediate(ly),” “direct(ly),” or “close(ly),” is used. For example, when a structure is described as being positioned “on,” “over,” “under,” “above,” “below,” “beneath,” “near,” “close to,” “adjacent to,” “beside,” or “next to” another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

In describing a temporal relationship, when the temporal order is described as, for example, “after,” “subsequent,” “next,” “before,” “preceding,” “prior to,” or the like, a case that is not consecutive or not sequential may be included unless a more limiting term, such as “just,” “immediate(ly),” or “direct(ly),” is used.

It is understood that, although the term “first,” “second,” or the like may be used herein to describe various elements, these elements should not be limited by these terms. These terms are only used to distinguish one element from another. For example, a first element could be a second element, and, similarly, a second element could be a first element, without departing from the scope of the present disclosure. Furthermore, the first element, the second element, and the like may be arbitrarily named according to the convenience of those skilled in the art without departing from the scope of the present disclosure. The terms “first,” “second,” and the like may be used to distinguish components from each other, but the functions or structures of the components are not limited by ordinal numbers or component names in front of the components.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element or layer is “connected,” “coupled,” “attached,” or “adhered” to another element or layer, the element or layer may not only be directly connected, coupled, attached, or adhered to another element or layer, but also be indirectly connected, coupled, attached, or adhered to another element or layer with one or more intervening elements or layers disposed or interposed between the elements or layers, unless otherwise specified.

For the expression that an element or layer “contacts,” “overlaps,” or the like with another element or layer, the element or layer may not only directly contact, overlap, or the like with another element or layer, but also indirectly contact, overlap, or the like with another element or layer with one or more intervening elements or layers disposed or interposed between the elements or layers, unless otherwise specified.

The terms such as a “line” or “direction” should not be interpreted only based on a geometrical relationship in which the respective lines or directions are parallel or perpendicular to each other, and may be meant as lines or directions having wider directivities within the range within which the components of the present disclosure may operate functionally.

The term “at least one” should be understood as including any and all combinations of one or more of the associated listed items. For example, the meaning of “at least one of a first item, a second item, and a third item” denotes the combination of items proposed from two or more of the first item, the second item, and the third item as well as only one of the first item, the second item, or the third item.

The expression of a first element, a second elements “and/or” a third element should be understood as one of the first, second and third elements or as any or all combinations of the first, second and third elements. By way of example, A, B and/or C may refer to only A; only B; only C; any or some combination of A, B, and C; or all of A, B, and C. Furthermore, an expression “element A/element B” may be understood as element A and/or element B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

Features of various aspects of the present disclosure may be partially or wholly coupled to or combined with each other and may be variously inter-operated, linked or driven together. The aspects of the present disclosure may be carried out independently from each other or may be carried out together in a co-dependent or related relationship. In one or more aspects, the components of each apparatus according to various aspects of the present disclosure are operatively coupled and configured.

Unless otherwise defined, the terms (including technical and scientific terms) used herein have the same meaning as commonly understood by one of ordinary skill in the art to which example aspects belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. In addition, for convenience of description, a scale, dimension, size, and thickness of each of the elements illustrated in the accompanying drawings may be different from an actual scale, dimension, size, and thickness, and thus, aspects of the present disclosure are not limited to a scale, dimension, size, and thickness illustrated in the drawings.

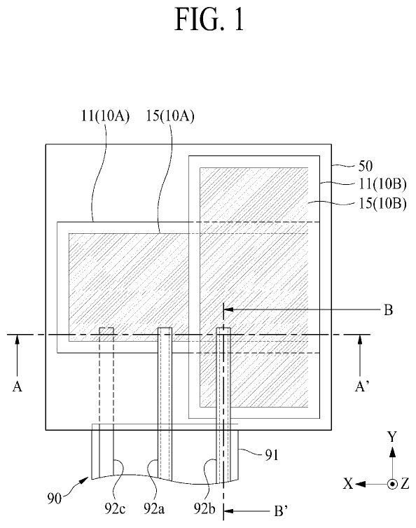

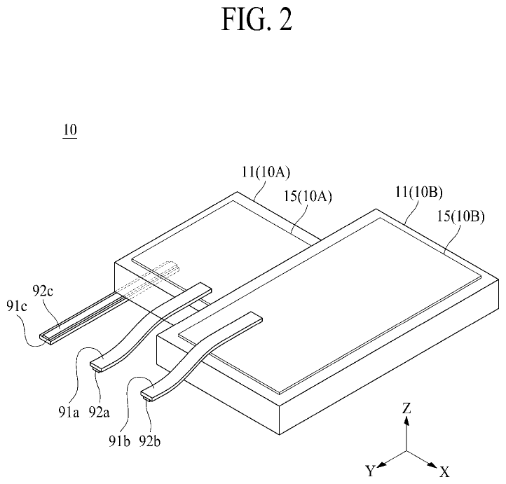

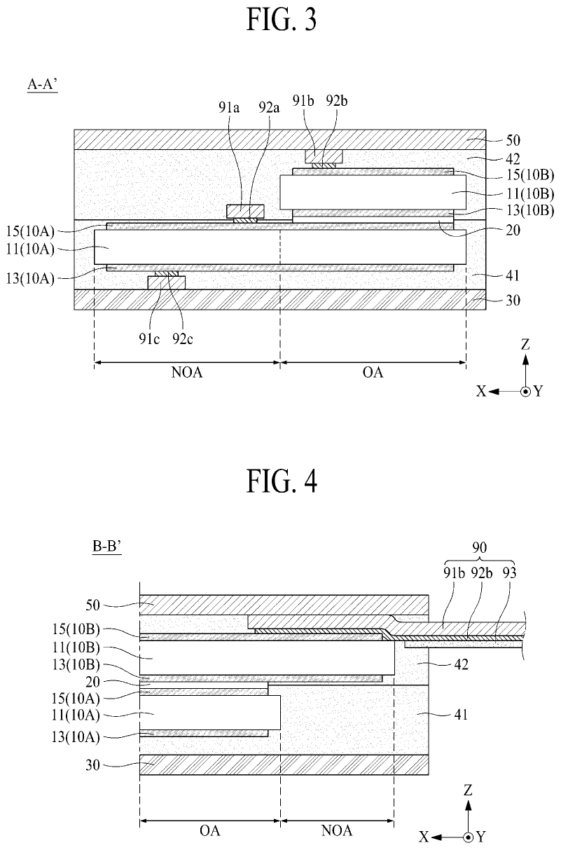

FIG. 1 illustrates a vibration apparatus according to an aspect of the present disclosure. FIG. 2 is a perspective view illustrating a connection structure between a vibration generating portion and a signal cable illustrated in FIG. 1 according to an aspect of the present disclosure. FIG. 3 is a cross-sectional view taken along line A-A′ illustrated in FIG. 1 according to an aspect of the present disclosure. FIG. 4 is a cross-sectional view taken along line B-B′ illustrated in FIG. 1 according to an aspect of the present disclosure.

Referring to FIGS. 1 to 4, a vibration apparatus according to an aspect of the present disclosure may include a vibration generating portion 10, a first cover member 30, a second cover member 50, and a signal cable 90.

The vibration generating part 10 may include a plurality of vibration parts 10A and 10B. For example, the vibration generating part 10 may include the plurality of vibration parts 10A and 10B which overlap each other or are overlaid. For example, the vibration generating part 10 may include the plurality of vibration parts 10A and 10B which are stacked or overlap each other. For example, the plurality of vibration parts 10A and 10B according to an aspect of the present disclosure may be arranged in different directions and stacked. For example, the plurality of vibration parts 10A and 10B according to an aspect of the present disclosure may be arranged in an intersection direction and stacked. For example, the vibration generating part 10 may include a first vibration part 10A and a second vibration part 10B stacked on the first vibration part 10A. For example, the first vibration part 10A and the second vibration part 10B according to an aspect of the present disclosure may be arranged in different directions and stacked. For example, the first vibration part 10A and the second vibration part 10B according to an aspect of the present disclosure may intersect with each other in different directions and may be stacked.

For example, the first vibration part 10A according to an aspect of the present disclosure may be disposed in one direction of a first direction X, a second direction Y intersecting with the first direction X, and a diagonal direction between the first direction X and the second direction Y. For example, the second vibration part 10B may be disposed in a direction intersecting with the first vibration part 10A among the first direction X, the second direction Y, and the diagonal direction.

The first vibration part 10A according to an aspect of the present disclosure may be disposed in the first direction X, and the second vibration part 10B may be disposed in the second direction Y intersecting with the first direction X. For example, each of the first vibration part 10A and the second vibration part 10B may have a rectangular shape. For example, each of the first vibration part 10A and the second vibration part 10B may include a long side and a short side based on a rectangular shape. For example, the first vibration part 10A and the second vibration part 10B may have a T-shape and may be stacked. Accordingly, one short side of the first vibration part 10A and one long side of the second vibration part 10B may be disposed in a same line. For example, one end (or one side) of the first vibration part 10A may overlap a center region of the second vibration part 10B.

Therefore, the first vibration part 10A and the second vibration part 10B according to an aspect of the present disclosure may include an overlap region OA and a non-overlap region NOA, which overlap each other. For example, the overlap region OA may be a stack region, a multi-layer region, or an intersection region. The non-overlap region NOA may be a non-stack region, a single-layer region, a non-intersection region, or a single vibration region. For example, the first vibration portion 10A and the second vibration portion 10B may be electrically connected to each other in the overlap region OA (or an intersection region).

According to an aspect of the present disclosure, the sound radiation region may be proportional to an area of the vibration generating part 10. For example, as an area of the vibration generating part 10 increases, the sound radiation region may increase. For example, in a case where the first vibration part 10A and the second vibration part 10B having a same size are arranged in a same direction and stacked, the sound radiation region may correspond to an area of the plurality of vibration parts 10A and 10B arranged in the same direction. For example, in a case where the first vibration part 10A and the second vibration part 10B are arranged in the same direction and stacked, the sound radiation region may correspond to a width and a thickness of the first vibration part 10A and a width and a thickness of the second vibration part 10B.

According to an aspect of the present disclosure, the first vibration part 10A and the second vibration part 10B may be arranged to intersect with each other in different directions and stacked, and thus, a total area of the vibration generating part 10 may increase. According to an aspect of the present disclosure, in a case where the first vibration part 10A and the second vibration part 10B are arranged in different directions and stacked, the total area of the vibration generating portion 10 may include all of the overlap region OA and the non-overlap region NOA. Accordingly, the sound radiation region of the vibration generating part 10 may increase to the overlap region OA and the non-overlap region NOA of the vibration generating part 10. Also, according to an aspect of the present disclosure, the overlap region OA may be provided, and thus, a sound pressure level characteristic and/or a sound characteristic of the overlap region OA may be further enhanced.

The plurality of vibration parts 10A and 10B or the first and second vibration parts 10A and 10B may be connected to or contact each other in the intersection region OA. For example, the plurality of vibration parts 10A and 10B or the first and second vibration parts 10A and 10B may contact each other by a medium such as a connection member 20. However, aspects of the present disclosure are not limited thereto, and the plurality of vibration parts 10A and 10B or the first and second vibration parts 10A and 10B according to an aspect of the present disclosure may be connected to or contact each other without a medium such as a connection member or a contact member.

Each of the first vibration part 10A and the second vibration part 10B may include a piezoelectric material, an electro active material, or a piezoelectric device, which has a piezoelectric effect. For example, the piezoelectric material (or the piezoelectric device) may have a characteristic where pressure or twisting is applied to a crystal structure by an external force, a potential difference occurs due to dielectric polarization caused by a relative position change of a positive (+) ion and a negative (−) ion, and a vibration is generated by an electric field based on a voltage applied thereto.

Each of the first vibration part 10A and the second vibration part 10B may include a vibration layer 11, a first electrode layer 13, and a second electrode layer 15.

According to an aspect of the present disclosure, the vibration layer 11 of each of the first vibration part 10A and the second vibration part 10B may have a same ceramic crystalline structure, or may have different ceramic structures. For example, the vibration layer 11 of the first vibration part 10A and the vibration layer 11 of the second vibration part 10B may include single crystalline ceramic or polycrystalline ceramic. For example, one of the vibration layer 11 of the first vibration part 10A and the vibration layer 11 of the second vibration part 10B may include single crystalline ceramic, and the other may include polycrystalline ceramic.

In a stack structure between the first and second vibration parts 10A and 10B, to prevent electrical short circuit between electrode layers vertically adjacent to each other, each of the first electrode layer 13 and the second electrode layer 15 may be formed at the other portion, except an edge portion of the vibration layer 11. For example, a distance between a lateral surface of each of the first electrode layer 13 and the second electrode layer 15 and a lateral surface of the vibration layer 11 may be at least 0.5 mm or more, but aspects of the present disclosure are not limited thereto. For example, the distance between the lateral surface of each of the first electrode layer 13 and the second electrode layer 15 and the lateral surface of the vibration layer 11 may be at least 1 mm or more, but aspects of the present disclosure are not limited thereto.

According to an aspect of the present disclosure, the second electrode layer 15 of the first vibration part 10A may contact or be electrically connected to the first electrode layer 13 of the second vibration part 10B. For example, the second electrode layer 15 of the first vibration part 10A may contact or be electrically connected to the first electrode layer 13 of the second vibration part 10B by the connection member 20. For example, the connection member 20 may include a conductive material. For example, the conductive material may include a copper (Cu) or silver (Ag) material, but aspects of the present disclosure are not limited thereto. For example, the connection member 20 may include a conductive double-sided adhesive member. For example, the connection member 20 may include a conductive double-sided tape, a conductive double-sided adhesive member, or a conductive double-sided cushion tape, but aspects of the present disclosure are not limited thereto. The connection member 20 according to an aspect of the present disclosure may include a metal layer, a first tacky layer which is coupled or connected to a first surface of the metal layer and is electrically connected to or contacts the second electrode layer 15 of the first vibration part 10A, and a second tacky layer which is coupled or connected to a second surface of the metal layer and is electrically connected to or contacts the first electrode layer 13 of the second vibration part 10B. Each of the first and second tacky layers may include or contain a conductive material. For example, the connection member 20 may be an interlayer connection member, an internal connection member, or an electrode connection member, but aspects of the present disclosure are not limited thereto.

The vibration layer 11 of the first vibration part 10A and the vibration layer 11 of the second vibration part 10B may be polarized (or polling) in a same direction, or may be polarized in opposite directions. For example, a polarization direction (or a polling direction) formed in the vibration layer 11 of the first vibration part 10A may be a direction opposite to a polarization direction formed in the vibration layer 11 of the second vibration part 10B. According to an aspect of the present disclosure, the second electrode layer 15 of the first vibration part 10A and the first electrode layer 13 of the second vibration part 10B may be connected to each other, and when the polarization direction formed in the vibration layer 11 of the first vibration part 10A is a direction opposite to the polarization direction formed in the vibration layer 11 of the second vibration part 10B, the first vibration part 10A and the second vibration part 10B may be displaced (or vibrated or driven) in the same direction, and thus, a vibration width (or displacement with or driving width) of the vibration generating part 10 may be maximized, thereby enhancing a sound pressure level.

The first vibration part 10A according to an aspect of the present disclosure may be disposed in the first direction X perpendicular to the second direction Y. The first vibration part 10A may include a vibration layer 11, a first electrode layer 13, and a second electrode layer 15.

The vibration layer 11 of the first vibration part 10A may be configured between the first electrode layer 13 and the second electrode layer 15.

The vibration layer 11 may include a piezoelectric material (or an electroactive material) having a piezoelectric effect. The vibration layer 11 may include a ceramic-based material for implementing a relatively high vibration, or may include piezoelectric ceramic having a perovskite-based crystalline structure.

The piezoelectric ceramic may include single crystalline ceramic having a single-crystal structure, or may include a ceramic material or polycrystalline ceramic having a poly-crystal structure. A piezoelectric material including single crystalline ceramic may include one or more of aluminum phosphate (for example, α-AlPO₄), silicon dioxide (for example, α-SiO₂), lithium niobate (LiNbO₃), terbium molydbate (Tb₂(MoO₄)₃), lithium tetraborate (Li₂B₄O₇), ZnO or a combination thereof. The piezoelectric material including single crystalline ceramic may include a lead zirconate titanate (PZT)-based material including lead (Pb), zirconium (Zr), and titanium (Ti) or may include a lead zirconate nickel niobate (PZNN)-based material including lead (Pb), zirconium (Zr), nickel (Ni), and niobium (Nb), but aspects of the present disclosure are not limited thereto. As another example, the vibration layer 11 may include at least one of CaTiO₃, BaTiO₃, and SrTiO₃ without lead (Pb), but aspects of the present disclosure are not limited thereto.

The first electrode layer 13 of the first vibration part 10A may be configured between the vibration layer 11 and the first cover member 30. The first electrode layer 13 of the first vibration part 10A may be disposed at a first surface (or a lower surface) of the vibration layer 11.

The first electrode layer 13 may have a same size as that of the vibration layer 11, or may have a size which is less than that of the vibration layer 11. For example, the first electrode layer 13 may have a single electrode shape. For example, the first electrode layer 13 may have a tetragonal shape. For example, an end (or a lateral surface) of the first electrode layer 13 may be apart from an end (or a lateral surface) of the vibration layer 11, and thus, an electrical connection (or short circuit) between the first electrode layer 13 and the second electrode layer 15 may be prevented.

A third signal line 92c may be configured at a lower surface of the first electrode layer 13 of the first vibration part 10A. The first electrode layer 13 of the first vibration part 10A may be connected to the third signal line 92c. The first electrode layer 13 of the first vibration part 10A may be electrically connected to the third signal line 92c.

The second electrode layer 15 of the first vibration part 10A may be disposed at a second surface (or an upper surface), which is different from or opposite to the first surface, of the vibration layer 11. The second electrode layer 15 of the first vibration part 10A may have a size which is less than that of the vibration layer 11, but aspects of the present disclosure are not limited thereto.

A first signal line 92a may be configured at an upper surface of the second electrode layer 15 of the first vibration part 10A. The second electrode layer 15 of the first vibration part 10A may be connected to the first signal line 92a. The second electrode layer 15 of the first vibration part 10A may be electrically connected to the first signal line 92a.

The second vibration part 10B may be disposed in a direction which differs from the first vibration part 10A. The second vibration part 10B may be disposed in a direction intersecting with the first vibration part 10A. For example, the second vibration part 10B may be disposed in the second direction Y. The second vibration part 10B may be disposed in the second direction Y vertically intersecting with the first direction X.

Therefore, the first vibration part 10A and the second vibration part 10B according to an aspect of the present disclosure may include an intersection region. For example, the intersection region may be an overlap region OA where the first vibration part 10A overlaps the second vibration part 10B. For example, the first vibration part 10A and the second vibration part 10B according to an aspect of the present disclosure may include an overlap region OA where the first vibration part 10A overlaps the second vibration part 10B and a non-overlap region NOA where the first vibration part 10A does not overlap the second vibration part 10B.

For example, in the overlap region OA, one of the first electrode layer 13 and the second electrode layer 15 of the first vibration part 10A may be electrically connected to or directly contact one of the first electrode layer 13 and the second electrode layer 15 of the second vibration part 10B.

According to an aspect of the present disclosure, a second surface of the first vibration part 10A and a first surface of the second vibration part 10B facing each other may contact each other. For example, in the overlap region OA, the second surface (or an upper surface) of the first vibration part 10A and the first surface (or a lower surface) of the second vibration part 10B facing each other may be electrically connected to each other. For example, in the overlap region OA, the second surface (or the upper surface) of the first vibration part 10A and the first surface (or the lower surface) of the second vibration part 10B facing each other may be connected to each other by the connection member 20. However, aspects of the present disclosure are not limited thereto. For example, in the overlap region OA, the second surface (or the upper surface) of the first vibration part 10A and the first surface (or the lower surface) of the second vibration part 10B facing each other may be connected to or contact each other without a medium.

The second vibration part 10B may include a vibration layer 11, a first electrode layer 13, and a second electrode layer 15.

The vibration layer 11 of the second vibration part 10B may be configured between the first electrode layer 13 and the second electrode layer 15. The vibration layer 11 of the second vibration part 10B may include the same piezoelectric material or an electroactive material as that of the vibration layer 11 of the first vibration part 10A. The vibration layer 11 may include a ceramic-based material capable of implementing a relatively high vibration, or may include piezoelectric ceramic having a perovskite-based crystalline structure, but aspects of the present disclosure are not limited thereto.

The first electrode layer 13 of the second vibration part 10B may be disposed at a first surface (or a lower surface) of the vibration layer 11. The first electrode layer 13 of the second vibration part 10B may have the same size as that of the vibration layer 11, or may have a size which is less than that of the vibration layer 11 of the second vibration part 10B. For example, the first electrode layer 13 of the second vibration part 10B may have a single electrode shape. For example, the first electrode layer 13 of the second vibration part 10B may have a tetragonal shape. For example, an end (or a lateral surface) of the first electrode layer 13 of the second vibration part 10B may be spaced apart from an end (or a lateral surface) of the vibration layer 11 of the second vibration part 10B, and thus, an electrical connection (or short circuit) between the first electrode layer 13 and the second electrode layer 15 of the second vibration part 10B may be prevented.

In the overlap region OA, the second electrode layer 15 of the first vibration part 10A may be connected to the first electrode layer 13 of the second vibration part 10B. In the overlap region OA, the second electrode layer 15 of the first vibration part 10A may be electrically connected to the first electrode layer 13 of the second vibration part 10B. In the second vibration part 10B, a lower surface of the first electrode layer 13 disposed in the overlap region OA in a lower surface of the first electrode layer 13 may contact an upper surface of the second electrode layer 15 of the first vibration part 10A disposed in the overlap region OA. In the second vibration part 10B, the lower surface of the first electrode layer 13 disposed in the overlap region OA in the lower surface of the first electrode layer 13 may be electrically connected to the upper surface of the second electrode layer 15 of the first vibration part 10A disposed in the overlap region OA.

For example, the second electrode layer 15 of the first vibration part 10A may be connected to the first electrode layer 13 of the second vibration part 10B, and thus, the first electrode layer 13 of the second vibration part 10B may be electrically connected to the first signal line 92a. For example, the first electrode layer 13 of the second vibration part 10B and the second electrode layer 15 of the first vibration part 10A may be used as a common electrode. For example, the same signal may be applied to the first electrode layer 13 of the second vibration part 10B and the second electrode layer 15 of the first vibration part 10A through the second signal line 92a.

The second electrode layer 15 of the second vibration part 10B may be disposed at a second surface (or an upper surface), which is different from or opposite to the first surface, of the vibration layer 11. The second electrode layer 15 of the second vibration part 10B may have a size which is less than that of the vibration layer 11, but aspects of the present disclosure are not limited thereto.

A second signal line 92b may be configured at an upper surface of the second electrode layer 15 of the second vibration part 10B. The second electrode layer 15 of the second vibration part 10B may be connected to the second signal line 92b. The second electrode layer 15 of the second vibration part 10B may be electrically connected to the second signal line 92b.

One or more of the first electrode layer 13 and the second electrode layer 15 according to an example aspect of the present disclosure may include a transparent conductive material, a semitransparent conductive material, or an opaque conductive material. For example, the transparent or semitransparent conductive material may include one or more of indium tin oxide (ITO) or indium zinc oxide (IZO), but aspects of the present disclosure are not limited thereto. The opaque conductive material may include one or more of gold (Au), silver (Ag), platinum (Pt), palladium (Pd), molybdenum (Mo), magnesium (Mg), carbon, or glass frit-including silver (Ag), or an alloy thereof, but aspects of the present disclosure are not limited thereto. According to another example aspect of the present disclosure, each of the first electrode layer 13 and the second electrode layer 15 may include silver (Ag) having a low resistivity, to enhance an electrical characteristic and/or a vibration characteristic of the vibration layer 11. For example, carbon may be a carbon material including carbon black, ketjen black, carbon nanotube, and graphite.

In the first electrode layer 13 and the second electrode layer 15 including glass frit-including silver (Ag), a content of glass frit may be about 1 wt % or more to about 12 wt % or less, but aspects of the present disclosure are not limited thereto. The glass frit may include a material based on PbO or Bi₂O₃, but aspects of the present disclosure are not limited thereto.

The vibration layer 11 may be polarized (or polling) by a certain voltage applied to the first electrode layer 13 and the second electrode layer 15 in a certain temperature atmosphere or a temperature atmosphere which is changed from a high temperature to a room temperature, but aspects of the present disclosure are not limited thereto. For example, the vibration layer 11 may alternately repeat contraction and/or expansion based on an inverse piezoelectric effect based on a sound signal (or a voice signal) applied to the first electrode layer 13 and the second electrode layer 15 from the outside, and thus, may vibrate. For example, the vibration layer 11 may vibrate based on a vertical-direction vibration and a horizontal-direction vibration by the first electrode layer 13 and the second electrode layer 15. A displacement (or vibration or driving) of a vibration member may increase based on the horizontal-direction contraction and/or expansion of the vibration layer, and thus, a vibration of a vibration apparatus may be further enhanced.

The first cover member 30 may be attached on the second cover member 50 by a first adhesive layer 41 and a second adhesive layer 42 at a periphery of each of the first vibration part 10A and the second vibration part 10B.

The first cover member 30 may be configured under the first vibration part 10A. The first cover member 30 may be configured under a non-overlap region NOA of the second vibration part 10B. The first cover member 30 may be configured to cover the first vibration part 10A of the vibration generating part 10. The first cover member 30 may be configured to cover a non-overlap region NOA of the lower surface of the second vibration part 10B. For example, the first cover member 30 may be configured to cover the first electrode layer 13 of the first vibration part 10A. Therefore, the first cover member 30 may protect the first surface of the vibration generating part 10 and the first electrode layer 13 of the first vibration part 10A. For example, the first cover member 30 may be configured to cover the first electrode layer 13 disposed in a non-overlap region NOA, which does not overlap the first vibration part 10A, of the lower surface of the second vibration part 10B. Accordingly, the first cover member 30 may protect the first electrode layer 13 of the second vibration part 10B disposed in the non-overlap region NOA.

The second cover member 50 may be configured on the second vibration part 10B. The second cover member 50 may be configured on a non-overlap region NOA of the first vibration part 10A. The second cover member 50 may be configured to cover the second vibration part 10B of the vibration generating part 10. The second cover member 50 may be configured to cover a non-overlap region NOA of the upper surface of the first vibration part 10A. For example, the second cover member 50 may be configured to cover the second electrode layer 15 of the second vibration part 10B. Therefore, the second cover member 50 may protect the second surface of the vibration generating part 10 and the second electrode layer 15 of the second vibration part 10B. For example, the second cover member 50 may be configured to cover the second electrode layer 15 disposed in a non-overlap region NOA, which does not overlap the second vibration part 10B, of the upper surface of the first vibration part 10A. Accordingly, the second cover member 50 may protect the second electrode layer 15 of the first vibration part 10A disposed in the non-overlap region NOA.

The first adhesive layer 41 and the second adhesive layer 42 may be configured between the first cover member 30 and the second cover member 50 to surround the first vibration part 10A and the second vibration part 10B.

The first cover member 30 may be connected or coupled to at least a portion of the first surface of the vibration generating part 10 by the first adhesive layer 41. The first cover member 30 may be connected or coupled to at least a portion of the first electrode layer 13 of the first vibration part 10A by the first adhesive layer 41. The first cover member 30 may be connected or coupled to at least a portion of the first electrode layer 13 of the second vibration part 10B provided in the non-overlap region NOA by the first adhesive layer 41. For example, the first cover member 30 may be connected or coupled to at least a portion of the first surface of the vibration generating part 10 by a film laminating process by the first adhesive layer 41. For example, the first cover member 30 may be connected or coupled to at least a portion of each of the first electrode layer 13 and the second vibration part 10B of the first vibration part 10A by a film laminating process by the first adhesive layer 41.

The second cover member 50 may be connected or coupled to at least a portion of the second surface of the vibration generating part 10 by the second adhesive layer 42. The second cover member 50 may be connected or coupled to at least a portion of each of the second electrode layer 15 of the second vibration part 10B and the second electrode layer 15 of the first vibration part 10A provided in the non-overlap region NOA by the second adhesive layer 42. For example, the second cover member 50 may be connected or coupled to at least a portion of the second surface of the vibration generating part 10 by a film laminating process by the second adhesive layer 42. For example, the second cover member 30 may be connected or coupled to at least a portion of each of the second electrode layer 15 of the second vibration part 10B and the second electrode layer 15 of the first vibration part 10A provided in the non-overlap region NOA by a film laminating process by the second adhesive layer 42.

Each of the first cover member 30 and the second cover member 50 according to an example aspect of the present disclosure may include one or more materials of plastic, fiber, cloth, paper, leather, rubber, and wood, but aspects of the present disclosure are not limited thereto. For example, the first cover member 30 and the second cover member 50 may include the same material or different materials. For example, each of the first cover member 30 and the second cover member 50 may be a polyimide film or a polyethylene terephthalate film, but aspects of the present disclosure are not limited thereto.

According to another example aspect of the present disclosure, one or more of the first cover member 30 and the second cover member 50 may include an adhesive member. For example, one or more of the first cover member 30 and the second cover member 50 may include an adhesive member coupled or adhered to the vibration layer 11, and a protection member (or a delamination member) which covers or protects the adhesive member. For example, the adhesive member may include an electrical insulation material which has adhesive properties and is capable of compression and decompression. For example, the first cover member 30 may include an adhesive member coupled or adhered to the vibration layer 11 and a protection member (or a delamination member) which covers or protects the adhesive member.

The signal cable 90 may be implemented to be connected to each of the first and second vibration parts 10A and 10B of the vibration generating part 10 at one side of the vibration generating part 10. The signal cable 90 may be connected to each of the first and second vibration parts 10A and 10B, between the first cover member 30 and the second cover member 50. The signal cable 90 may include signal lines which are connected to the first and second vibration parts 10A and 10B, between the first cover member 30 and the second cover member 50.

An end portion (or a distal end portion) of the signal cable 90 may be disposed at or inserted (or accommodated) into a portion between one periphery portion of the first cover member 30 and one periphery portion of the second cover member 50. The one periphery portion of the first cover member 30 and the one periphery portion of the second cover member 50 may accommodate or vertically cover a portion of the signal cable 90. Accordingly, the signal cable 90 may be provided as one body with the vibration generating part 10. For example, the vibration apparatus according to an example aspect of the present disclosure may be a vibration apparatus which is provided as one body with the signal cable 90. For example, the signal cable 90 may be configured as a flexible cable, a flexible printed circuit cable, a flexible flat cable, a single-sided flexible printed circuit, a single-sided flexible printed circuit board (PCB), a flexible multilayer printed circuit, or a flexible multilayer PCB, but aspects of the present disclosure are not limited thereto.

The signal cable 90 according to another aspect of the present disclosure may include a base member 91 and a plurality of signal lines 92a to 92c. For example, the signal cable 90 may include the base member 91 and first to third signal lines 92a to 92c.

The base member 91 may include a transparent or an opaque plastic material. For example, the base member 91 may include one or more of synthetic resins such as fluorine resin, polyimide-based resin, polyurethane-based resin, polyester-based resin, polyethylene-based resin, and polypropylene-based resin, but aspects of the present disclosure are not limited thereto. The base member 91 may be a base film or a base insulation film, but aspects of the present disclosure are not limited thereto.

The base member 91 may have a certain width in a first direction X and may extend lengthwise along the second direction Y intersecting with the first direction X.

According to an aspect of the present disclosure, the total number of signal lines 92a to 92c provided in the signal cable 90 may be less than the total number of electrode layers 13 and 15 provided in the first vibration part 10A and the second vibration part 10B. For example, in an aspect of the present disclosure, total four electrodes 13 and 14 configured in each of the first vibration part 10A and the second vibration part 10B may be provided, and total three signal lines 92a to 92c configured in the signal cable 90 may be provided. Accordingly, in an aspect of the present disclosure, comparing with connecting a signal line for each electrode layer, the number of signal lines may be reduced, and a thickness of a vibration apparatus may decrease.

The first signal line 92a according to an aspect of the present disclosure may be connected to the first vibration part 10A and the second vibration part 10B. The first signal line 92a may be electrically connected to the second electrode layer 15 of the first vibration part 10A. The first signal line 92a may be electrically connected to the second electrode layer 13 of the second vibration part 10B. The first signal line 92a may be electrically connected to the first electrode layer 13 of the second vibration part 10B connected to the second electrode layer 15 of the first vibration part 10A. Accordingly, the first signal line 92a may supply a driving signal, supplied from a vibration driving circuit, to the second electrode layer 13 of the second vibration part 10B and the second electrode layer 15 of the first vibration part 10A.

The second signal line 92b may be configured on the second vibration part 10B. The second signal line 92b may be electrically connected to the second vibration part 10B. An end portion (or distal end portion or one side) of the second signal line 92b may be electrically connected to at least a portion of the second electrode layer 15 of the second vibration part 10B. Accordingly, the second signal line 92b may supply the driving signal, supplied from the vibration driving circuit, to the second electrode layer 15 of the second vibration part 10B.

The third signal line 92c may be configured under the first vibration part 10A. An end portion (or distal end portion or one side) of the third signal line 92c may be configured between the first cover member 30 and the first electrode layer 13 of the first vibration part 10A. For example, the end portion (or distal end portion or one side) of the third signal line 92c may be electrically connected to at least a portion of the first electrode layer 13 of the first vibration part 10A, at one edge portion of the first cover member 30. For example, the end portion (or distal end portion or one side) of the third signal line 92c may be electrically connected to at least a portion of the first electrode layer 13 of the first vibration part 10A. Accordingly, the third signal line 92c may supply the driving signal, supplied from the vibration driving circuit, to the first electrode layer 13 of the first vibration part 10A.

For example, when the first signal line 92a is a common signal line, signals supplied to the second signal line 92b and the third signal line 92c may be applied with the same phase. Accordingly, the contraction and/or expansion of the first vibration part 10A and the second vibration part 10B may be performed with the same phase (or the same direction). For example, the first signal line 92a may be a negative (−) electrode, and each of the second signal line 92b and the third signal line 92c may be a positive (+) electrode. As another example, the first signal line 92a may be a positive (+) electrode, and each of the second signal line 92b and the third signal line 92c may be a negative (−) electrode.

In the first vibration part 10A, the first electrode layer 13 may receive the driving signal through the third signal line 92c, and the second electrode layer 15 may receive the driving signal through the first signal line 92a. Accordingly, the first vibration part 10A may alternately repeat contraction and/or expansion, based on an inverse piezoelectric effect which is generated from the driving signal by the vibration layer 11, and thus, may vibrate (or displace or drive).

In the second vibration part 10B, the first electrode layer 13 may receive the driving signal through the first signal line 92a, and the second electrode layer 15 may receive the driving signal through the second signal line 92b. Accordingly, the second vibration part 10B may alternately repeat contraction and/or expansion, based on an inverse piezoelectric effect which is generated from the driving signal by the vibration layer 11, and thus, may vibrate (or displace or drive).

Each of the first vibration part 10A and the second vibration part 10B may be flexed (or displaced or driven) in the same shape. Therefore, in the vibration generating part 10 or the vibration apparatus, a vibration width (or a displacement width or a driving width) of the first vibration part 10A and a vibration width (or a displacement width or a driving width) of the second vibration part 10B may be summated and maximized. For example, in the vibration generating part 10 or the vibration apparatus, a vibration of the first vibration part 10A and a vibration of the second vibration part 10B may be reinforced, and thus, vibration efficiency or vibration characteristic may be enhanced and a vibration width (or a displacement width or a driving width) of the second vibration part 10B may be maximized, whereby a sound characteristic and/or a sound pressure level characteristic of a low-pitched sound band may be enhanced.

The signal cable 90 according to an example aspect of the present disclosure may further include an insulation member 93.

The insulation member 93 may be disposed at the first surface of the base member 91 to cover each of the first to third signal lines 92a to 92c other than the end portion of the signal cable 90. The insulation member 93 may be a protection layer, a coverlay, a coverlay layer, a cover film, an insulation film, or a solder mask, but aspects of the present disclosure are not limited thereto.

The signal cable 90 may include first to third extension portions 91a to 91c which respectively support the end portions (or distal end portions or one side) of the first to third signal lines 92a to 92c apart from one another.

The first extension portion 91a may extend in the second direction Y from an end (or one side) of an insulation member 93 covering the first signal line 92a disposed in the base member 91, and thus, may support the first signal line 92a. The first signal line 92a may be disposed on a lower surface (or a bottom surface) of the first extension portion 91a to be directly connected to the vibration generating portion 10.

The second extension portion 91b may extend in the second direction Y from an end (or one side) of the insulation member 93 covering the second signal line 92b disposed in the base member 91, and thus, may support the second signal line 92b. The second signal line 92b may be disposed on a lower surface (or a bottom surface) of the second extension portion 91b to be directly connected to the vibration generating part 10.

The third extension portion 91c may extend in the second direction Y from an end (or one side) of the insulation member 93 covering the third signal line 92c disposed in the base member 91, and thus, may support the third signal line 92c. The third signal line 92c may be disposed on a lower surface (or a bottom surface) of the third extension portion 91c to be directly connected to the vibration generating part 10.

The first to third extension portions 91a to 91c may be apart from one another between one edge portion of the first cover member 30 and one edge portion of the second cover member 50. Accordingly, the end portions (or distal end portions) of the first to third signal lines 92a to 92c may be apart from one another, and thus, may be individually bent or curved.

According to another aspect of the present disclosure, one or more of the first to third extension portions 91a to 91c of the signal cable 90 may be omitted. For example, each of the first to third signal lines 92a to 92c may protrude or extend in a finger shape from the base member 91 and may be electrically connected to or contact corresponding electrode layers 13 and 15, between the one edge portion of the first cover member 30 and the one edge portion of the second cover member 50. For example, the end portions (or distal end portions or one side) of the first to third extension portions 91a to 91c may be electrically connected to or contact the corresponding electrode layers 13 and 15 by a conductive double-sided tape, and thus, an adhesive force to the corresponding electrode layers 13 and 15 may be secured.

The end portion (or distal end portion or one side) of the signal cable 90 inserted (or accommodated) between the first cover member 30 and the second cover member 50 may be inserted (or accommodated) and fixed between the first cover member 30 and the second cover member 50 through a film laminating process which uses the first adhesive layer 41 formed in the first cover member 30 and the second adhesive layer 42 formed in the second cover member 50. Therefore, the first signal line 92a may be maintained with being electrically connected to the second electrode layer 15 of the first vibration part 10A, the second signal line 92b may be maintained with being electrically connected to the second electrode layer 15 of the second vibration part 10B, and the third signal line 92c may be maintained with being electrically connected to the first electrode layer 13 of the first vibration part 10A.

According to an aspect of the present disclosure, the end portion (or distal end portion or one side) of the signal cable 90 may be inserted (or accommodated) and fixed between the first cover member 30 and the second cover member 50, and thus, a connection defect between the vibration generating part 10 and the signal cable 90 caused by the movement of the signal cable 90 may be prevented.

In the vibration apparatus according to an aspect of the present disclosure, the first to third signal lines 92a to 92c of the signal cable 90 may be connected to the electrode layer of the vibration generating part 10 between the first cover member 30 and the second cover member 50, and thus, a soldering process for an electrical connection between the vibration generating part 10 and the signal cable 90 may not be needed, thereby simplifying a structure and a manufacturing process of a vibration apparatus. Also, the vibration apparatus according to another aspect of the present disclosure may include the plurality of vibration parts 10A and 10b which overlap or overlay each other to vibrate (or displace or drive) in the same direction, and thus, vibration efficiency or vibration characteristic may be enhanced and a vibration width (or a displacement width or a driving width) may be maximized, thereby enhancing a sound characteristic and/or a sound pressure level characteristic of a pitched sound band including the low-pitched sound band.

Moreover, in the vibration apparatus according to an aspect of the present disclosure, the first signal line 92a of the signal cable 90 may be provided between the second cover member 50 and the first vibration part 10A, and the second signal line 92b may be provided between the second cover member 50 and the second vibration part 10B. Therefore, in the vibration apparatus according to an aspect of the present disclosure, the first signal line 92a may not be provided between the plurality of vibration parts 10A and 10B, and thus, a thickness of the vibration apparatus may decrease and a step height caused by the first signal line 92a may decrease. Also, in the vibration apparatus according to an aspect of the present disclosure, a crack may be prevented from occurring in bonding or attaching the first cover member 30 to the second cover member 50 due to a step height which occurs when connecting signal lines. For example, in the vibration apparatus according to an aspect of the present disclosure, all of the first and second signal lines 92a and 92b may be provided on the upper surface of the vibration generating part 10, and thus, in a case where a signal line is provided between the first vibration part 10A and the second vibration part 10B, the occurrence of a defect such as a crack caused by bonding between the first vibration part 10A and the second vibration part 10B may be prevented.

Moreover, in an aspect of the present disclosure, the plurality of vibration parts 10A and 10B may be arranged to intersect with one another in different directions, and thus, a sound radiation region may enlarge, thereby providing a vibration apparatus and an apparatus including the same for enhancing a sound pressure level characteristic and/or a sound characteristic of a sound.

Moreover, according to an aspect of the present disclosure, because the plurality of vibration parts 10A and 10B are arranged to intersect with one another in different directions and a position of the signal cable 90 may be optimized, a thickness and a weight of a vibration apparatus may decrease. Accordingly, according to an aspect of the present disclosure, a vibration apparatus which is lightweight may be implemented.

Also, in an aspect of the present disclosure, a defect such as a crack of a vibration apparatus may be prevented, and thus, a yield rate may be enhanced, thereby implementing process optimization by reducing production energy. Also, according to an aspect of the present disclosure, a manufacturing process may be simplified, and thus, process optimization may be realized by reducing production energy.

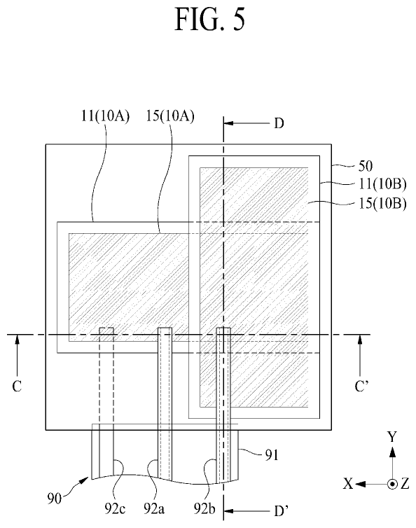

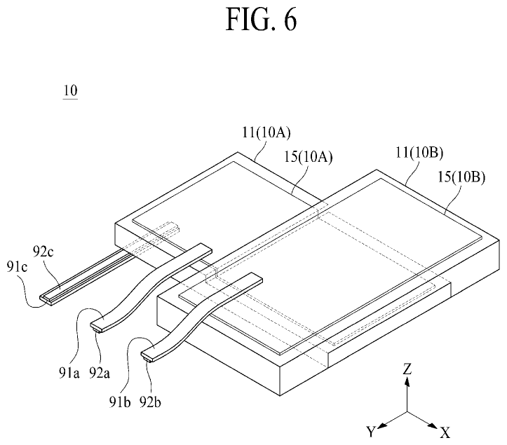

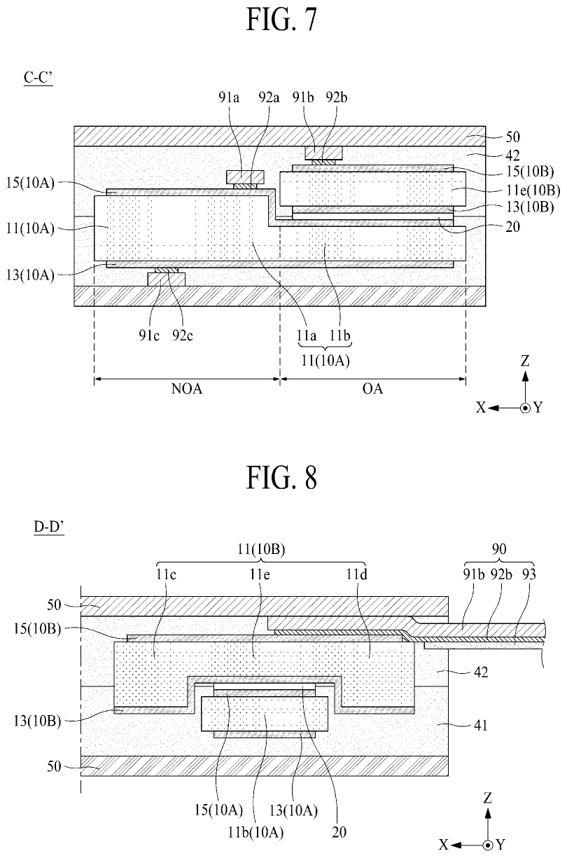

FIG. 5 illustrates a vibration apparatus according to another aspect of the present disclosure. FIG. 6 is a perspective view illustrating a connection structure between a vibration generating portion and a signal cable illustrated in FIG. 5 according to another aspect of the present disclosure. FIG. 7 is a cross-sectional view taken along line C-C′ illustrated in FIG. 5 according to another aspect of the present disclosure. FIG. 8 is a cross-sectional view taken along line D-D′ illustrated in FIG. 5 according to another aspect of the present disclosure. Except for a shape of a vibration layer, a vibration apparatus according to another aspect of the present disclosure may be the substantially same as an aspect of the present disclosure. Hereinafter, therefore, only a vibration layer and elements relevant thereto will be described, and repeated descriptions of the same elements may be omitted.

Referring to FIGS. 5 and 8, a first vibration part 10A according to another aspect of the present disclosure may include a first vibration region 11a and a second vibration region 11b provided in parallel, and the second vibration part 10B may include third to fifth vibration regions 11c to 11e provided in parallel. For example, one of the first vibration region 11a and the second vibration region 11b of the first vibration part 10A may overlap one of the third to fifth vibration regions 11c to 11e of the second vibration part 10B. For example, one of the first vibration region 11a and the second vibration region 11b of the first vibration part 10A may be electrically connected to one of the third to fifth vibration regions 11c to 11e of the second vibration part 10B.

Referring to FIGS. 5 to 8, a vibration layer 11 of the first vibration part 10A according to an aspect of the present disclosure may include the first vibration region 11a and the second vibration region 11b. For example, the first vibration region 11a may be a non-overlap region NOA, and the second vibration region 11b may be an overlap region OA. For example, the first vibration region 11a may be an intersection region. For example, the second vibration region 11b may be configured to be stepped in a direction toward a lower surface (or a bottom surface) of the first vibration region 11a from an upper surface (or a top surface) of the first vibration region 11a. Therefore, the first vibration region 11a and the second vibration region 11b may have different thicknesses. For example, a region, overlapping the second vibration part 10B, of the first vibration region 11a and the second vibration region 11b may have a relatively thin thickness. For example, a region, overlapping the second vibration part 10B, of the first vibration region 11a and the second vibration region 11b may have a thinner thickness than a region that does not overlap. For convenience of description, in another aspect of the present disclosure, an example where the second vibration region 11b overlaps the second vibration part 10B may be described. Therefore, for example, a thickness of the second vibration region 11b may have a thickness which is thinner than that of the first vibration region 11a. For example, a thickness of the second vibration region 11b may have a thickness of about 50% of a thickness of the first vibration region 11a, but aspects of the present disclosure are not limited thereto. For example, in the first vibration part 10A, the vibration layer 11 may be configured to have a partially thin thickness by a tape casting process. For example, in the first vibration part 10A, the vibration layer 11 may be configured so that the first vibration region 11a and the second vibration region 11b have different thicknesses, based on the tape casting process. For example, the tape casting process may mix a piezoelectric material powder with a binder, a plasticizer, and a solvent to manufacture a slurry, and then, may manufacture a green sheet (or a molding sheet) on a material such as a release film.

A vibration layer 11 of the second vibration part 10B according to another aspect of the present disclosure may include the third vibration region 11c, the fourth vibration region 11d, and the fifth vibration region 11e. For example, the third vibration region 11c and the fourth vibration region 11d may be arranged in parallel with the fifth vibration region 11e therebetween. For example, the fifth vibration region 11e may be configured between the third vibration region 11c and the fourth vibration region 11d. For example, the third vibration region 11c and the fourth vibration region 11d may be a non-overlap region NOA. For example, the fifth vibration region 11e may be an overlap region OA. For example, the overlap region OA may be an intersection region where the first vibration portion 10A intersects with the second vibration part 10B.

For example, the third vibration region 11c and the fourth vibration region 11d may have the same thickness. For example, each of the third vibration region 11c and the fourth vibration region 11d and the fifth vibration region 11e may have different thicknesses. For example, a region, overlapping the first vibration part 10A, of the third to fifth vibration regions 11c to 11e of the second vibration part 10B may have a relatively thin thickness. For example, a region, overlapping the first vibration part 10A, of the third to fifth vibration regions 11c to 11e of the second vibration part 10B may have a thinner thickness than a region that does overlap. For example, a thickness of the fifth vibration region 11e may have a thickness which is thinner than that of the third and fourth vibration regions 11c and 11d. For example, the fifth vibration region 11e may have a thickness of about 50% of a thickness of the third vibration region 11c. For example, the fifth vibration region 11e may have a thickness of about 50% of a thickness of the fourth vibration region 11d. For example, in the second vibration part 10A, the vibration layer 11 may be configured to have a partially thin thickness by a tape casting process. For example, in the second vibration part 10B, the vibration layer 11 may be configured so that the third vibration region 11c, the fourth vibration region 11d, and the fifth vibration region 11e have different thicknesses, based on the tape casting process. According to an aspect of the present disclosure, one of the first vibration region 11a and the second vibration region 11b of the first vibration part 10A may overlap the fifth vibration region 11e between the third vibration region 11c and the fourth vibration region 11d of the second vibration part 10B. For example, the second vibration region 11b of the first vibration part 10A may overlap the fifth vibration region 11e of the second vibration part 10B. For example, the second vibration region 11b of the first vibration part 10A may be inserted (or accommodated) into the fifth vibration region 11e of the second vibration part 10B. For example, the second vibration region 11b of the first vibration part 10A may have the same thickness as that of the fifth vibration region 11e of the second vibration part 10B, but aspects of the present disclosure are not limited thereto.

A second electrode layer 15 of the first vibration part 10A may be configured on the first vibration region 11a and the second vibration region 11b. A first electrode layer 13 of the second vibration part 10B may be configured under the third to fifth vibration regions 11c to 11e. In the overlap region OA, the second electrode layer 15 of the first vibration portion 10A may be electrically connected to the first electrode layer 13 of the second vibration portion 10B.

A first signal line 92a may be electrically connected to the second electrode layer 15 of the first vibration part 10A. The first signal line 92a may be electrically connected to the first electrode layer 13 of the second vibration part 10B. The first signal line 92a may be electrically connected to the first electrode layer 13 of the second vibration part 10B connected to the second electrode layer 15 of the first vibration part 10A. Accordingly, the third signal line 92c may supply the driving signal, supplied from the vibration driving circuit, to the first electrode layer 13 of the first electrode layer 13 of the second vibration part 10B and the second electrode layer 15 of the first vibration part 10A.

Another aspect of the present disclosure may have substantially the substantially same effect as an aspect of the present disclosure described above with reference to FIGS. 1 to 4.

Moreover, in an aspect of the present disclosure, in the overlap region OA, a thickness of the second vibration region 11b of the first vibration part 10A may be less than that of the first vibration region 11a, a thickness of the fifth vibration region 11c of the second vibration part 10B may be less than that of the third and fourth vibration regions 11c and 11d, and the second vibration region 11b may be inserted (or accommodated) into the fifth vibration region 11e, and thus, a step height of the first vibration part 10A and the second vibration part 10B may decrease and a thickness and a weight of the vibration generating part 10 may be further reduced. Accordingly, according to another aspect of the present disclosure, a vibration apparatus which is lightweight may be implemented.

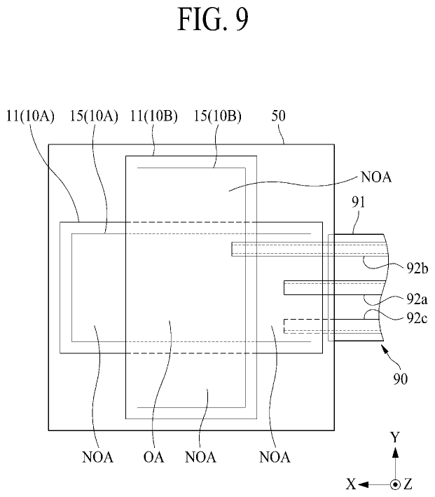

FIG. 9 illustrates a vibration apparatus according to another aspect of the present disclosure. Except for an arrangement relationship between a first vibration part 10A and a second vibration part 10B, other aspects of the present disclosure may be the same as an aspect of the present disclosure described above with reference to FIGS. 1 to 4. Hereinafter, therefore, only different elements will be described.

Referring to FIG. 9, a first vibration part 10A and a second vibration part 10B according to another aspect of the present disclosure may be arranged in different directions and stacked. For example, the first vibration part 10A may be disposed in a first direction X, and the second vibration part 10B may be disposed in a second direction Y intersecting with the first direction X. For example, the first vibration part 10A and the second vibration part 10B may be disposed to have a “+”-shape. For example, in another aspect of the present disclosure, a center region of the first vibration part 10A and a center region of the second vibration part 10B may be disposed to intersect with each other. For example, the center region of the first vibration part 10A may overlap the center region of the second vibration part 10B. The center region of the first vibration part 10A and the center region of the second vibration part 10B may be an overlap region OA (or an intersection region). For example, one end (or one side) and the other end (or the other side) of the first vibration part 10A may be a non-overlap region NOA which does not overlap the second vibration part 10B. For example, one end (or one side) and the other end (or the other side) of the second vibration part 10B may be a non-overlap region NOA which does not overlap the first vibration part 10A.

A signal cable 90 may include a base member 91 and first to third signal lines 92a to 92c.

Based on an arrangement relationship between the first vibration part 10A and the second vibration part 10B, the base member 91 may have a certain width in the second direction Y and may extend long in the first direction X intersecting with the second direction Y.

Each of the first to third signal lines 92a to 92c according to an aspect of the present disclosure may be connected to the first vibration part 10A and the second vibration part 10B. The first signal line 92a may be electrically connected to at least a portion of a second electrode layer 15 of the first vibration part 10A. An end portion (or distal end portion or one side) of the second signal line 92b may be electrically connected to at least a portion of a second electrode layer 15 of the second vibration part 10B, at one edge portion of a second cover member 50. An end portion (or distal end portion or one side) of the third signal line 92c may be electrically connected to at least a portion of a first electrode layer of the first vibration part 10A.

Based on the arrangement relationship (or an intersection direction) between the first vibration part 10A and the second vibration part 10B, as illustrated in FIG. 9, an example where the signal cable 90 is disposed at a right side of a vibration apparatus has been described, but aspects of the present disclosure are not limited thereto. For example, the signal cable 90 may be disposed at one side of the vibration apparatus within a range for minimizing a length of each of the first to third signal lines 92a to 92c. For example, when the center region of the first vibration part 10A overlaps the center region of the second vibration part 10B, the signal cable 90 according to another aspect of the present disclosure may be disposed at one of a left side, a right side, an upper side, and a lower side of the vibration apparatus.

In another aspect of the present disclosure, because the plurality of vibration parts 10A and 10B are arranged in different directions and a position of the signal cable 90 is optimized, a sound radiation region may enlarge, and a thickness and a weight of a vibration apparatus may decrease. Accordingly, according to an aspect of the present disclosure, a sound characteristic and/or a sound pressure level characteristic of a vibration apparatus may be enhanced, and a vibration apparatus which is lightweight may be implemented.

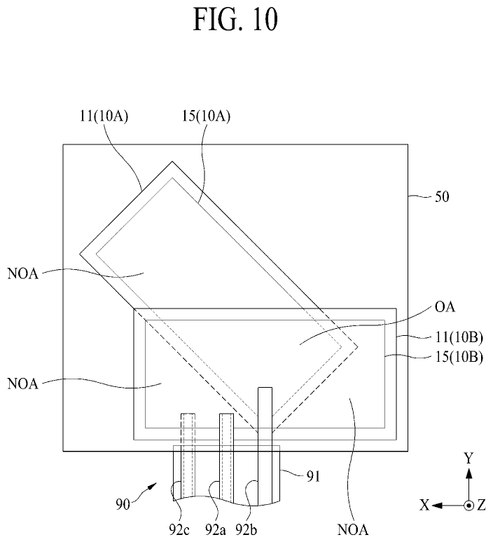

FIG. 10 illustrates a vibration apparatus according to another aspect of the present disclosure. Except for an arrangement relationship between a first vibration part 10A and a second vibration part 10B, other aspects of the present disclosure may be the substantially same as an aspect of the present disclosure described above with reference to FIGS. 1 to 4. Hereinafter, therefore, only different elements will be described.

Referring to FIG. 10, a first vibration part 10A and a second vibration part 10B according to another aspect of the present disclosure may be arranged in different directions and stacked. For example, the first vibration part 10A and the second vibration part 10B according to another aspect of the present disclosure may be arranged in an intersection direction and stacked.

For example, the first vibration part 10A may be disposed in a first direction X. For example, the second vibration part 10B may be disposed in in one direction of a first direction X, a second direction Y intersecting with the first direction X, and a diagonal direction therebetween. For example, the second vibration part 10B may be disposed to have an angle between 30 degrees and 60 degrees with respect to the first direction X. For example, each of the first vibration part 10A and the second vibration part 10B may have a rectangular shape. For example, a long side of the first vibration part 10A may be parallel to the first direction X, and a short side of the first vibration prat 10A may be parallel to the second direction Y. For example, the second vibration part 10B may intersect with the first vibration part 10A and may be disposed in a diagonal direction with respect to one long side of the first vibration part 10A.

Based on an arrangement relationship between the first vibration part 10A and the second vibration part 10B, a signal cable 90 may be disposed at a lower side in FIG. 10, but aspects of the present disclosure are not limited thereto and may be disposed in a region for minimizing a length of the signal cable 90.

In another aspect of the present disclosure, because the plurality of vibration parts 10A and 10B are arranged in different directions and a position of the signal cable 90 is optimized, a sound radiation region may enlarge, and a thickness and a weight of a vibration apparatus may decrease. Accordingly, according to an aspect of the present disclosure, a sound characteristic and/or a sound pressure level characteristic of a vibration apparatus may be enhanced, and a vibration apparatus which is lightweight may be implemented.

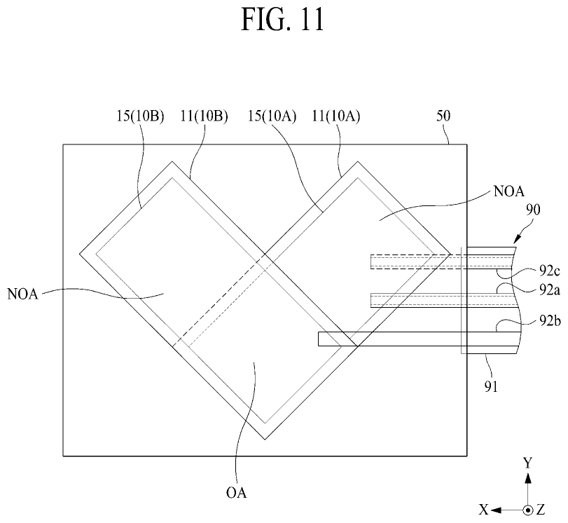

FIG. 11 illustrates a vibration apparatus according to another aspect of the present disclosure. Except for an arrangement relationship between a first vibration part 10A and a second vibration part 10B, other aspects of the present disclosure may be the substantially same as an aspect of the present disclosure described above with reference to FIGS. 1 to 4. Hereinafter, therefore, only different elements will be described.

Referring to FIG. 11, a first vibration part 10A and a second vibration part 10B according to another aspect of the present disclosure may be arranged in different directions and stacked. For example, the first vibration part 10A and the second vibration part 10B may be disposed to have a “┐”-shape. For example, one end (or one side) of the first vibration part 10A may overlap one end (or one side) of the second vibration part 10B. For example, the one end (or one side) of the first vibration part 10A and the one end (or one side) of the second vibration part 10B may be an overlap region OA. For example, the other end (or the other side) of the first vibration part 10A and the other end (or the other side) of the second vibration part 10B may be a non-overlap region NOA where the other end (or the other side) of the first vibration part 10A does not overlap the other end (or the other side) of the second vibration part 10B.

Based on an arrangement relationship between the first vibration part 10A and the second vibration part 10B, a signal cable 90 may be disposed at a right or upper side in FIG. 11, but aspects of the present disclosure are not limited thereto and may be disposed in a region for minimizing a length of the signal cable 90.

In another aspect of the present disclosure, because the plurality of vibration parts 10A and 10B are arranged in different directions and a position of the signal cable 90 is optimized, a sound radiation region may enlarge, and a thickness and a weight of a vibration apparatus may decrease. Accordingly, according to an aspect of the present disclosure, a sound characteristic and/or a sound pressure level characteristic of a vibration apparatus may be enhanced, and a vibration apparatus which is lightweight may be implemented.

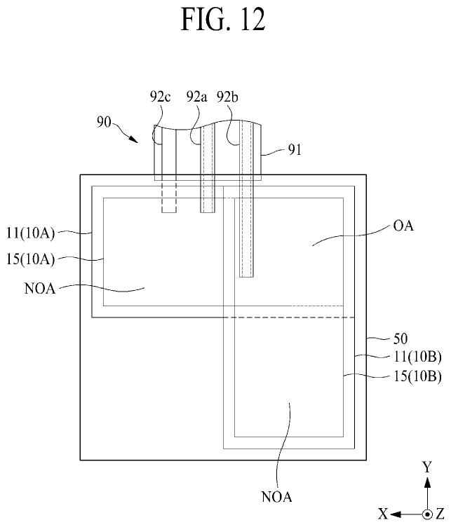

FIG. 12 illustrates a vibration apparatus according to another aspect of the present disclosure. Except for an arrangement relationship between a first vibration pars 10A and a second vibration part 10B, other aspects of the present disclosure may be the substantially same as an aspect of the present disclosure described above with reference to FIGS. 1 to 4. Hereinafter, therefore, only different elements will be described.

Referring to FIG. 12, in a vibration apparatus according to another aspect of the present disclosure, the vibration generating part 10 described above with reference to FIG. 11 has rotated to have an angle between 30 degrees and 60 degrees with respect to the first direction X. Accordingly, in another aspect of the present disclosure, a first vibration part 10A and a second vibration part 10B may be covered by a first cover member 30 and a second cover member 50 each having an area which is greater than the aspect described above with reference to FIG. 11.

Based on an arrangement relationship between the first vibration part 10A and the second vibration part 10B, a signal cable 90 may be disposed at a right or upper side in FIG. 12, but aspects of the present disclosure are not limited thereto and may be disposed in a region for minimizing a length of the signal cable 90.

In another aspect of the present disclosure, because the plurality of vibration parts 10A and 10B are arranged in different directions and a position of the signal cable 90 is optimized, a sound radiation region may enlarge, and a thickness and a weight of a vibration apparatus may decrease. Accordingly, according to an aspect of the present disclosure, a sound characteristic and/or a sound pressure level characteristic of a vibration apparatus may be enhanced, and a vibration apparatus which is lightweight may be implemented.

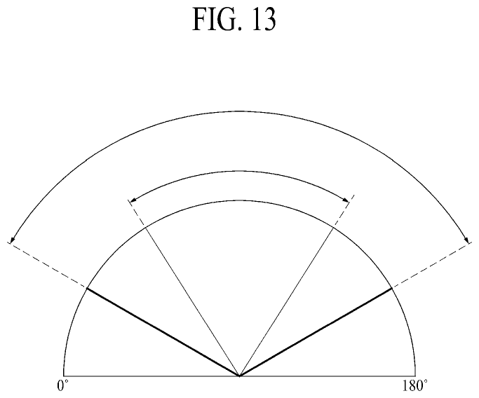

FIG. 13 illustrates a sound radiation angle of a vibration apparatus according to an aspect of the present disclosure.

The inventors have prepared a sample as a comparative example and an aspect to compare sound radiation angles of a vibration apparatus according to an aspect of the present disclosure.

In a vibration apparatus according to the comparative example, a first vibration portion and a second vibration portion have been stacked in the same direction, a signal line has been connected to each of an upper surface and a lower surface of the first vibration portion, and a signal line has been connected to each of an upper surface and a lower surface of the second vibration portion.

In a vibration apparatus according to an aspect, like an aspect of the present disclosure described above with reference to FIGS. 1 to 4, a first vibration portion and a second vibration portion may be arranged in different directions and may then be stacked, a third signal line may be connected to a first electrode layer of the first vibration portion, a first signal line may be connected to a second electrode layer of the first vibration portion, and a second signal line may be connected to a second electrode layer of the second vibration portion.

In FIG. 13, a thin solid line represents a sound radiation angle of the vibration apparatus according to the comparative example, and a thick solid line represents a sound radiation angle of the vibration apparatus according to an aspect of the present disclosure.

Referring to FIG. 13, it may be seen that a sound radiation angle according to the comparative example has a value of 90 degrees or less, and a sound radiation angle according to an aspect of the present disclosure represents a sound radiation angle of 120 degrees to 130 degrees. For example, it may be seen that the sound radiation angle according to an aspect of the present disclosure represents a sound radiation angle of 126 degrees.

Accordingly, according to an aspect of the present disclosure, the plurality of vibration portions 10A and 10B may be arranged in different directions, and a position of the signal cable 90 may be optimized, and thus, it may be seen that a sound radiation region is capable of enlarging.

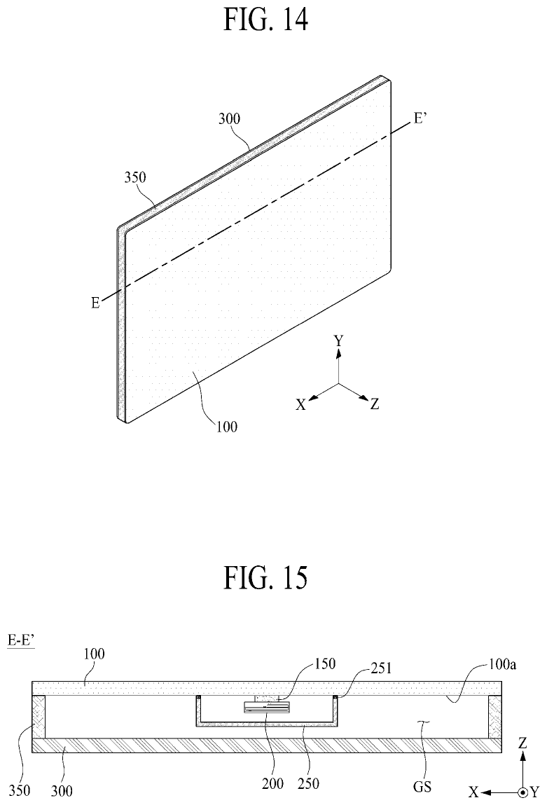

FIG. 14 illustrates an apparatus according to an aspect of the present disclosure. FIG. 15 is a cross-sectional view taken along line E-E′ illustrated in FIG. 14 according to an aspect of the present disclosure.

Referring to FIGS. 14 and 15, an apparatus according to an example aspect of the present disclosure may include a passive vibration member 100 and one or more vibration generating apparatuses 200.

The apparatus according to an example aspect of the present disclosure may be a display apparatus, a sound apparatus, a sound generating apparatus, a sound bar, an analog signage, or a digital signage, or the like, but aspects of the present disclosure are not limited thereto.

The display apparatus may include a display panel including a plurality of pixels which implement a black/white or color image and a driver configured to drive the display panel. An image according to an example aspect of the present disclosure may include an electronic image, a digital image, a still image, or a video image, but aspects of the present disclosure are not limited thereto. For example, the display panel may be an organic light emitting display panel, a light emitting diode display panel, an electrophoresis display panel, an electro-wetting display panel, a micro light emitting diode display panel, or a quantum dot light emitting display panel, or the like, but aspects of the present disclosure are not limited thereto. For example, in the organic light emitting display panel, a pixel may include an organic light emitting device such as an organic light emitting layer or the like, and the pixel may be a subpixel which implements any one of a plurality of colors configuring a color image. Therefore, an apparatus according to an example aspect of the present disclosure may include a set device (or a set apparatus) or a set electronic device such as a notebook computer, a television (TV), a computer monitor, an equipment apparatus including an automotive apparatus or another type apparatus for vehicles, or a mobile electronic device such as a smartphone, or an electronic pad, or the like which is a complete product (or a final product) including a display panel such as an organic light emitting display panel, a liquid crystal display panel, or the like.

The analog signage may be an advertising signboard, a poster, a noticeboard, or the like. The analog signage may include content such as a sentence, a picture, and a sign, or the like. The content may be disposed at the passive vibration member 100 of the apparatus to be visible. For example, the content may be directly attached on the passive vibration member 100 and the content may be printed or the like on a medium such as paper, and the medium may be attached on the passive vibration member 100.

The passive vibration member 100 may vibrate based on driving (or vibration) of the one or more vibration generating apparatuses 200. For example, the passive vibration member 100 may generate one or more of a vibration and a sound based on driving of the one or more vibration generating apparatuses 200.

The passive vibration member 100 according to an example aspect of the present disclosure may be a display panel including a display area (or a screen) having a plurality of pixels which implement a black/white or color image. Thus, the passive vibration member 100 may generate one or more of a vibration and a sound based on driving of the one or more vibration generating apparatuses 200. For example, the passive vibration member 100 may vibrate based on a vibration of the vibration generating apparatus 200 while a display area is displaying an image, and thus, may generate or output a sound synchronized with the image displayed on the display area. For example, the passive vibration member 100 according to an example aspect of the present disclosure may be a vibration object, a display member, a display panel, a signage panel, a passive vibration plate, a front cover, a front member, a vibration panel, a sound panel, a passive vibration panel, a sound output plate, a sound vibration plate, or a video screen, but aspects of the present disclosure are not limited thereto.

According to another example aspect of the present disclosure, the passive vibration member 100 may be a vibration plate including a metal material or a nonmetal material (or a complex nonmetal material), which has a material characteristic suitable for outputting a sound based on a vibration of each of the one or more vibration generating apparatuses 200. For example, the passive vibration member 100 may be a vibration plate including one or more materials of metal, plastic, paper, fiber, cloth, wood, leather, rubber, glass, carbon, and mirror. For example, the paper may be a cone paper for speakers. For example, the cone paper may be pulp or foam plastic, but aspects of the present disclosure are not limited thereto.

The passive vibration member 100 according to another example aspect of the present disclosure may include a display panel including a pixel displaying an image, or may include a non-display panel. For example, the passive vibration member 100 may include one or more of a display panel including a pixel configured to display an image, a screen panel on which an image is to be projected from a display apparatus, a lighting panel, a light emitting diode lighting panel, an organic light emitting lighting panel, an inorganic light emitting lighting panel, a signage panel, a vehicular interior material, a vehicular exterior material, a vehicular glass window, a vehicular seat interior material, a ceiling material of a building, an interior material of a building, a glass window of a building, an interior material of an aircraft, a glass window of an aircraft, and mirror, but aspects of the present disclosure are not limited thereto. For example, the non-display panel may be a light emitting diode lighting panel (or apparatus), an organic light emitting diode lighting panel (or apparatus), or an inorganic light emitting diode lighting panel (or apparatus), but aspects of the present disclosure are not limited thereto.

The one or more vibration generating apparatuses 200 may be configured to vibrate the passive vibration member 100. The one or more vibration generating apparatuses 200 may be configured to be connected to a rear surface 100a of the passive vibration member 100 by a connection member 150. Accordingly, the one or more vibration generating apparatuses 200 may vibrate the passive vibration member 100, and thus, may generate or output one or more of a vibration and a sound, based on a vibration of the passive vibration member 100.

The one or more vibration generating apparatuses 200 may include one or more of the vibration apparatuses described above with reference to FIGS. 1 to 13. Accordingly, the descriptions of the vibration apparatuses provided with reference to FIGS. 1 to 13 may be applicable to the vibration apparatuses illustrated with reference to FIGS. 14 and 15, and thus, like reference numerals may refer to like elements and repetitive descriptions thereof may be omitted.

The connection member 150 may be disposed between at least a portion of the vibration generating apparatus 200 and the passive vibration member 100. The connection member 150 may be connected between at least a portion of the vibration generating apparatus 200 and the passive vibration member 100. The connection member 150 according to an example aspect of the present disclosure may be connected between a center portion, except a periphery portion (or an edge portion), of the vibration generating apparatus 200 and the passive vibration member 100. For example, the connection member 150 may be connected between the center portion of the vibration generating apparatus 200 and the passive vibration member 100, based on a partial attachment scheme. The center portion (or a middle portion) of the vibration generating apparatus 200 may be a center of a vibration, and thus, a vibration of the vibration generating apparatus 200 may be efficiently transferred to the passive vibration member 100 through the connection member 150. The periphery portion (or the edge portion) of the vibration generating apparatus 200 may be in a state where the periphery portion (or the edge portion) of the vibration generating apparatus 200 is raised from each of the connection member 150 and the passive vibration member 100 without being connected to the connection member 150 and/or the passive vibration member 100, and thus, when a flexural vibration (or a bending vibration) of the vibration generating apparatus 200 is performed, a vibration of the edge portion of the vibration generating apparatus 200 may not be reduced (prevented) by the connection member 150 and/or the passive vibration member 100, and thus, a vibration width (or a displacement width or a driving width) of the vibration generating apparatus 200 may increase. Accordingly, a vibration width (or a displacement width or a driving width) of the passive vibration member 100 based on a vibration of the vibration generating apparatus 200 may increase, and thus, a sound characteristic and a sound pressure level characteristic of a low-pitched sound band generated based on a vibration of the passive vibration member 100 may be further enhanced.

According to another example aspect of the present disclosure, the connection member 150 may be connected to or attached on or at an entire front surface of the one or more vibration generating apparatuses 200 and the rear surface 100a of the passive vibration member 100, based on a front attachment scheme.

The connection member 150 according to an example aspect of the present disclosure may include a material including an adhesive layer which is good in adhesive force or attaching force with respect to the rear surface 100a of the passive vibration member 100 or the display panel and each of the one or more vibration generating apparatuses 200. For example, the connection member 150 may include a foam pad, a double-sided tape, an adhesive, or the like, but aspects of the present disclosure are not limited thereto. For example, an adhesive layer of the connection member 150 may include epoxy, acryl, silicone, or urethane, but aspects of the present disclosure are not limited thereto. For example, the adhesive layer of the connection member 150 may include an acryl-based material, having a characteristic where an adhesive force is relatively good and hardness is high, comparted to a urethane-based material. Accordingly, a vibration of each of the one or more vibration generating apparatuses 200 may be well transferred to the passive vibration member 100.

The apparatus according to an example aspect of the present disclosure may further include a supporting member 300 and a coupling member 350.

The supporting member 300 may be disposed at the rear surface 100a of the passive vibration member 100. The supporting member 300 may be disposed at the rear surface 100a of the passive vibration member 100 to cover the vibration generating apparatus 200. The supporting member 300 may be disposed at the rear surface 100a of the passive vibration member 100 to cover an entire of the rear surface 100a of the passive vibration member 100 and the vibration generating apparatus 200. For example, the supporting member 300 may have a size which is equal to that of the passive vibration member 100. For example, the supporting member 300 may cover the rear surface 100a of the passive vibration member 100 with the vibration generating apparatus 200 and a gap space GS therebetween. For example, the supporting member 300 may cover the entire rear surface 100a of the passive vibration member 100 with the vibration generating apparatus 200 and the gap space GS therebetween. The gap space GS may be provided by the coupling member 350 disposed between the passive vibration member 100 and the supporting member 300 facing each other. The gap space GS may be referred to as an air gap, an accommodating space, a vibration space, and a sound sounding box, but aspects of the present disclosure are not limited thereto.

The supporting member 300 may include one or more materials of a glass material, a metal material, and a plastic material. The supporting member 300 may have a stack structure where one or more materials of a glass material, a metal material, and a plastic material are stacked.

Each of the passive vibration member 100 and the supporting member 300 may have a square shape or a rectangular shape, but aspects of the present disclosure are not limited thereto. For example, each of the passive vibration member 100 and the supporting member 300 may have a polygonal shape, a non-polygonal shape, a circular shape, or an oval shape. For example, in a case where the apparatus according to an example aspect of the present disclosure is applied to a sound apparatus or a sound bar, each of the passive vibration member 100 and the supporting member 300 may have a rectangular shape where a long-side length is twice or longer than a short-side length, but aspects of the present disclosure are not limited thereto.

The coupling member 350 may be configured to be connected between a rear edge portion (or a rear periphery portion) of the passive vibration member 100 and a front edge portion (or a front periphery portion) of the supporting member 300, and thus, the gap space GS may be provided between the passive vibration member 100 and the supporting member 300 facing each other.

The coupling member 350 according to an example aspect of the present disclosure may include an elastic material which has adhesive properties and is capable of compression and decompression. For example, the coupling member 350 may include a double-side tape, a single-sided tape, or a double-side adhesive foam pad, but aspects of the present disclosure are not limited thereto. For example, the coupling member 350 may include an elastic pad such as a rubber pad or a silicone pad, which has adhesive properties and is capable of compression and decompression. For example, the coupling member 350 may be formed by an elastomer.

As another example, the supporting member 300 may further include a sidewall portion which supports the rear edge portion (or the rear periphery portion) of the passive vibration member 100. The sidewall portion of the supporting member 300 may protrude or be bent toward the rear edge portion (or the rear periphery portion) of the passive vibration member 100 from the front edge portion (or the front periphery portion) of the supporting member 300, and thus, the gap space GS may be provided between the passive vibration member 100 and the supporting member 300. In this case, the coupling member 350 may be configured to be connected between the sidewall portion of the supporting member 300 and the rear edge portion (or the rear periphery portion) of the passive vibration member 100. Accordingly, the supporting member 300 may cover the one or more vibration generating apparatuses 200 and may support the rear surface 100a of the passive vibration member 100. For example, the supporting member 300 may cover the one or more vibration generating apparatuses 200 and may support the rear edge portion (or the rear periphery portion) of the passive vibration member 100.

As another example, the passive vibration member 100 may further include a sidewall portion which is connected to the front edge portion (or the front periphery portion) of the supporting member 300. The sidewall portion of the passive vibration member 100 may protrude or be bent toward the front edge portion (or the front periphery portion) of the supporting member 300 from the rear edge portion (or the rear periphery portion) of the passive vibration member 100, and thus, the gap space GS may be provided between the passive vibration member 100 and the supporting member 300. The passive vibration member 100 may increase in stiffness by the sidewall portion thereof. In this case, the coupling member 350 may be configured to be connected between the sidewall portion of the passive vibration member 100 and the rear edge portion (or the rear periphery portion) of the supporting member 300. Accordingly, the supporting member 300 may cover the one or more vibration generating apparatuses 200 and may support the rear surface 100a of the passive vibration member 100. For example, the supporting member 300 may cover the one or more vibration generating apparatuses 200 and may support the rear edge portion (or the rear periphery portion) of the passive vibration member 100.

The apparatus according to an example aspect of the present disclosure may further include one or more enclosures 250.

The enclosure 250 may be connected or coupled to the rear edge portion (or the rear periphery portion) of the passive vibration member 100 to individually cover the one or more vibration generating apparatuses 200. For example, the enclosure 250 may be connected or coupled to the rear surface 100a of the passive vibration member 100 by a coupling member 251. The enclosure 250 may configure a sealing space, which covers or surrounds the one or more vibration generating apparatuses 200, at the rear surface 100a of the passive vibration member 100. For example, the enclosure 250 may be a sealing member, a sealing cap, a scaling box, or a sound box, but aspects of the present disclosure are not limited thereto. The sealing space may be an air gap, a vibration space, a sound space, or a sounding box, but aspects of the present disclosure are not limited thereto.

The enclosure 250 may include one or more materials of a metal material and a nonmetal material (or a complex nonmetal material). For example, the enclosure 250 may include one or more materials of metal, plastic, and wood, but aspects of the present disclosure are not limited thereto.

The enclosure 250 according to an example aspect of the present disclosure may maintain a constant impedance component based on air acting on the passive vibration member 100 when the passive vibration member 100 or the vibration generating apparatus 200 vibrates. For example, air around the passive vibration member 100 may resist to a vibration of the passive vibration member 100 and may act as an impedance component having a resistance and a reactance component, which vary based on a frequency. Accordingly, the enclosure 250 may configure a sealing space, which surrounds the one or more vibration generating apparatuses 200, at the rear surface 100a of the passive vibration member 100, and thus, may maintain a constant impedance component (or an air impedance or an elastic impedance) acting on the passive vibration member 100 with air, thereby enhancing a sound characteristic and/or a sound pressure level characteristic of a low-pitched sound band and the sound quality of a high-pitched sound band.

A vibration apparatus and an apparatus including the vibration apparatus according to one or more example aspects of the present disclosure are described below.

A vibration apparatus according to one or more example aspects of the present disclosure may comprise a first cover member, a second cover member, and a first vibration part and a second vibration part between the first cover member and the second cover member. The first vibration part and the second vibration part may be arranged in different directions.

According to one or more aspects of the present specification, the first vibration part and the second vibration part may be arranged in an intersection direction therebetween.

According to one or more aspects of the present disclosure, the first vibration part may be disposed in one direction among a first direction, a second direction intersecting with the first direction, and a diagonal direction between the first direction and the second direction. The second vibration part may be disposed in a direction intersecting with the first vibration part among the first direction, the second direction, and the diagonal direction.

According to one or more aspects of the present disclosure, the first vibration part and the second vibration part may be electrically connected to each other in an intersection region.

According to one or more aspects of the present disclosure, each of the first vibration part and the second vibration part may comprise a vibration layer including a piezoelectric material, a first electrode layer at a first surface of the vibration layer, and a second electrode layer at a second surface opposite to the first surface of the vibration layer.

According to one or more aspects of the present disclosure, one of the first electrode layer and the second electrode layer of the first vibration part may be electrically connected to or contact one of the first electrode layer and the second electrode layer of the second vibration part.

According to one or more aspects of the present disclosure, the vibration apparatus may further comprise a signal cable. The signal cable may comprise a plurality of signal lines connected to the first vibration part and the second vibration part.

According to one or more aspects of the present disclosure, a total number of signal lines provided in the signal cable may be less than a total number of electrode layers provided in the first vibration part and the second vibration part.

According to one or more aspects of the present disclosure, the vibration apparatus may further comprise a signal cable. The signal cable may comprise a plurality of signal lines connected to the first vibration part and the second vibration part. The plurality of signal lines may comprise a first signal line connected to the second electrode layer of the first vibration part, a second signal line connected to the second electrode layer of the second vibration part, and a third signal line connected to the first electrode layer of the first vibration part.

According to one or more aspects of the present disclosure, a portion of the signal cable may be accommodated between the first cover member and the second cover member.

According to one or more aspects of the present disclosure, the vibration apparatus may further comprise a first adhesive layer and a second adhesive layer disposed between the first cover member and the second cover member to surround the first vibration part and the second vibration part.

According to one or more aspects of the present disclosure, the first cover member may be adhered to the second cover member by the first adhesive layer and the second adhesive layer, at a periphery of the first vibration part and the second vibration part.

According to one or more aspects of the present disclosure, the first vibration part may comprise a first vibration region and a second vibration region configured in parallel. The second vibration part may comprise third to fifth vibration regions configured in parallel.

According to one or more aspects of the present disclosure, one of the first vibration region and the second vibration region of the first vibration part may overlap one of the third to fifth vibration regions of the second vibration part.

According to one or more aspects of the present disclosure, one of the first vibration region and the second vibration region of the first vibration part may be electrically connected to one of the third to fifth vibration regions of the second vibration part.

According to one or more aspects of the present disclosure, a region, overlapping the second vibration part, of the first vibration region and the second vibration region of the first vibration part may have a relatively thin thickness. A region, overlapping the first vibration part, of the third to fifth vibration regions of the second vibration part may have a relatively thin thickness. A region, overlapping the second vibration portion, of the first vibration region and the second vibration region of the first vibration part has a relatively thinner thickness than a region that does not overlap. A region, overlapping the first vibration part, of the third to fifth vibration regions of the second vibration part has a thinner thickness than a region that does not overlap.

According to one or more aspects of the present disclosure, one of the first vibration region and the second vibration region of the first vibration part may overlap the fifth vibration region between the third vibration region and the fourth vibration region of the second vibration part.

According to one or more aspects of the present disclosure, the vibration apparatus may further comprise a connection member disposed in an overlap region between the first vibration part and the second vibration part.

According to one or more aspects of the present disclosure, the connection member may comprise a conductive material.

An apparatus according to one or more example aspects of the present disclosure may comprise a passive vibration member, and a vibration generating apparatus connected to the passive vibration member to vibrate the passive vibration member. The vibration generating apparatus may comprise the vibration apparatus including a first cover member, a second cover member, and a first vibration part and a second vibration part between the first cover member and the second cover member. The first vibration part and the second vibration part are arranged in different directions.

According to one or more aspects of the present disclosure, the vibration generating apparatus may have a sound radiation angle between 120 degrees and 130 degrees.

According to one or more aspects of the present disclosure, the apparatus may further comprise an enclosure disposed at a rear surface of the passive vibration member to cover the vibration generating apparatus.

According to one or more aspects of the present disclosure, the passive vibration member may comprise one or more of a display panel including a plurality of pixels configured to display an image, a screen panel on which an image is to be projected from a display apparatus, a light emitting diode lighting panel, an organic light emitting lighting panel, an inorganic light emitting lighting panel, a signage panel, an interior material of a vehicular means, an exterior material of a vehicular means, a glass window of a vehicular means, a seat interior material of a vehicular means, a ceiling of a vehicular means, a ceiling material of a building, an interior material of a building, a glass window of a building, an interior material of an aircraft, a glass window of an aircraft, metal, plastic, paper, fiber, cloth, leather, wood, rubber, glass, carbon, and a mirror.

A vibration apparatus according to one or more example aspects of the present disclosure may be applied to or included in a vibration generating apparatus and/or a sound generating apparatus provided in an apparatus. The vibration apparatus and apparatus comprising the same according to one or more example aspects of the present disclosure may be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. In addition, the vibration apparatus according to some example aspects of the present disclosure may be applied to or included in organic light-emitting lighting apparatuses or inorganic light-emitting lighting apparatuses. When the vibration apparatus of one or more example aspects of the present disclosure is applied to or included in lighting apparatuses, the vibration apparatus may act as a lighting device and a speaker. In addition, when the vibration apparatus according to some example aspects of the present disclosure is applied to or included in a mobile device, or the like, the vibration apparatus may be one or more of a speaker, a receiver, and a haptic device, but aspects of the present disclosure are not limited thereto.

It will be apparent to those skilled in the art that various modifications and variations may be made in the present disclosure without departing from the scope of the disclosures. Thus, it is intended that the present disclosure covers the modifications and variations of this disclosure provided they come within the scope of the appended claims and their equivalents.

What is claimed is:

1. A vibration apparatus, comprising:
a first cover member;
a second cover member; and
a first vibration part and a second vibration part disposed between the first cover member and the second cover member,
wherein the first vibration part and the second vibration part are arranged in different directions.

2. The vibration apparatus of claim 1, wherein the first vibration part and the second vibration part are arranged in an intersection direction therebetween.

3. The vibration apparatus of claim 1, wherein the first vibration part is disposed in one direction among a first direction, a second direction intersecting with the first direction, and a diagonal direction between the first direction and the second direction, and
wherein the second vibration part is disposed in a direction intersecting with the first vibration portion among the first direction, the second direction, and the diagonal direction.

4. The vibration apparatus of claim 2, wherein the first vibration part and the second vibration part are electrically connected to each other in an intersection region.

5. The vibration apparatus of claim 1, wherein each of the first vibration part and the second vibration part comprises:
a vibration layer including a piezoelectric material;
a first electrode layer disposed at a first surface of the vibration layer; and
a second electrode layer disposed at a second surface opposite to the first surface of the vibration layer.

6. The vibration apparatus of claim 5, wherein one of the first electrode layer and the second electrode layer of the first vibration part is electrically connected to or contacts one of the first electrode layer and the second electrode layer of the second vibration part.

7. The vibration apparatus of claim 5, further comprising a signal cable including a plurality of signal lines connected to the first vibration part and the second vibration part.

8. The vibration apparatus of claim 7, wherein a total number of signal lines provided in the signal cable is less than a total number of electrode layers provided in the first vibration part and the second vibration part.

9. The vibration apparatus of claim 5, further comprising a signal cable including a plurality of signal lines connected to the first vibration part and the second vibration part,
wherein the plurality of signal lines includes:
a first signal line connected to the second electrode layer of the first vibration part;
a second signal line connected to the second electrode layer of the second vibration part; and
a third signal line connected to the first electrode layer of the first vibration part.

10. The vibration apparatus of claim 9, wherein a portion of the signal cable is accommodated between the first cover member and the second cover member.

11. The vibration apparatus of claim 1, further comprising a first adhesive layer and a second adhesive layer disposed between the first cover member and the second cover member to surround the first vibration part and the second vibration part.

12. The vibration apparatus of claim 11, wherein the first cover member is adhered to the second cover member by the first adhesive layer and the second adhesive layer, at a periphery of the first vibration part and the second vibration part.

13. The vibration apparatus of claim 1, wherein the first vibration part includes a first vibration region and a second vibration region configured in parallel, and
wherein the second vibration part includes third to fifth vibration regions configured in parallel.

14. The vibration apparatus of claim 13, wherein one of the first vibration region and the second vibration region of the first vibration part overlaps one of the third to fifth vibration regions of the second vibration part.

15. The vibration apparatus of claim 14, wherein one of the first vibration region and the second vibration region of the first vibration part is electrically connected to one of the third to fifth vibration regions of the second vibration part.

16. The vibration apparatus of claim 14, wherein a region, overlapping the second vibration portion, of the first vibration region and the second vibration region of the first vibration part has a thinner thickness than a region that does not overlap, and
a region, overlapping the first vibration part, of the third to fifth vibration regions of the second vibration part has a thinner thickness than a region that does not overlap.

17. The vibration apparatus of claim 14, wherein one of the first vibration region and the second vibration region of the first vibration part overlaps the fifth vibration region between the third vibration region and the fourth vibration region of the second vibration part.

18. The vibration apparatus of claim 1, further comprising a connection member disposed in an overlap region between the first vibration part and the second vibration part.

19. The vibration apparatus of claim 18, wherein the connection member includes a conductive material.

20. An apparatus, comprising:
a passive vibration member; and
a vibration generating apparatus connected to the passive vibration member to vibrate the passive vibration member,
wherein the vibration generating apparatus comprises a vibration apparatus,
wherein the vibration apparatus comprises:
a first cover member;
a second cover member; and
a first vibration part and a second vibration part disposed between the first cover member and the second cover member, and
wherein the first vibration part and the second vibration part are arranged in different directions.

21. The apparatus of claim 20, wherein the vibration generating apparatus has a sound radiation angle between 120 degrees and 130 degrees.

22. The apparatus of claim 20, further comprising an enclosure disposed at a rear surface of the passive vibration member to cover the vibration generating apparatus.

23. The apparatus of claim 20, wherein the passive vibration member comprises one or more of a display panel including a plurality of pixels configured to display an image, a screen panel on which an image is to be projected from a display apparatus, a light emitting diode lighting panel, an organic light emitting lighting panel, an inorganic light emitting lighting panel, a signage panel, an interior material of a vehicular means, an exterior material of a vehicular means, a glass window of a vehicular means, a seat interior material of a vehicular means, a ceiling of a vehicular means, a ceiling material of a building, an interior material of a building, a glass window of a building, an interior material of an aircraft, a glass window of an aircraft, metal, plastic, paper, fiber, cloth, leather, wood, rubber, glass, carbon, and a mirror.
